(19) United States
(12) Patent Application Publication
(10) Pub. No.: US 2018/0107564 A1
(43) Pub. Date: Apr. 19, 2018

(54) AUTOMATIC BACK-UP SCHEDULING

(71) Applicant: Hewlett-Packard Indigo B.V., Amstelveen (NL)

(72) Inventors: Shaun Henry, Middleton, ID (US); Scott C. Clouthier, Garden City, ID (US); Olga Smirin, Nampa, ID (US)

(21) Appl. No.: 15/297,236

(22) Filed: Oct. 19, 2016

(51) Int. Cl. G06F 11/14

(52) U.S. Cl. CPC G06F 11/1461; G06F 2201/835

(57) ABSTRACT

Techniques are disclosed herein for a cloud computing system for backing up a device. The system includes a scheduling manager to schedule a back-up for the device to occur at a time based on a time zone in which the device is located and based on workday customs local to the device. The system also includes a data store for storing identification of the time zone and the workday customs.

### TECHNICAL FIELD

The present techniques relate generally to back-up of data. More specifically, the present techniques relate to a cloud technique to back up data from a device based on location of the device.

### BACKGROUND

The data on devices may be subject to periodic back-up. Indeed, a user may desire that some or all data on the device be saved to additional storage. Moreover, many devices having such data may communicate with a cloud.

### DESCRIPTION OF THE DRAWINGS

Certain examples are described in the following detailed description and in reference to the drawings, in which:

FIG. 1 is a block diagram of an example system for backing up a device in accordance with examples of the present techniques;

FIG. 2 is a block diagram of an example system for backing up a device in accordance with examples of the present techniques;

FIG. 3 is a process flow diagram of an example method for backing up a device in accordance with examples of the present techniques; and

FIG. 4 is a block diagram of an example computer-readable medium storing non-transitory, machine-readable instructions containing code to direct processing resources to schedule a device back-up in accordance with examples of the present techniques.

### DETAILED DESCRIPTION

Difficulties may occur when manual back-up of data from devices, such as computing devices or printers, relies on a user (or manager, owner, etc.) to remember to back up the device. Unfortunately, such manual back-ups are commonly forgotten and thus not implemented. Automatic back-ups can also prove difficult. For instance, an automatic back-up by a local or remote server in which each device is set to back up at a given time based on the server time may create significant load on the server and reduced performance because of multiple device back-ups occurring at the same time. Further, an automatic back-up based on an arbitrary predetermined time may not be the best time for the work effort at the location of the device and may not take into account local customs regarding workday time and shift changes, for example. Moreover, for a cloud management staff to set up a back-up time for each device may require that the cloud management staff understand the cultural workday and shift norms, so that the cloud management staff schedules a back-up during a time that does not negatively impact the work process at the device site.

Certain examples herein provide solutions to these aforementioned issues. For example, the present techniques may relate generally to automatic configuration of a device back-up schedule based upon geographical location of the device. In particular, a back-up schedule may be dynamically configured taking into account the geographical location and time zone of the device, cultural work times local to the device, and so on, to schedule a back-up time beneficial to the owner of the device. Benefits may include reduction of downtime, capture of significant changes to the data (e.g., device settings of a printer or printing press, such as page size, media type, substrate thickness, resolution, print speed, etc.), and utilization of natural breaks in the work cycle (such as end of day or end of shift) for a given culture or a given work environment.

These solutions address the previously-mentioned issues. As discussed, the backing up of device data or device settings is often performed manually, when the device owner remembers to do so. Further, for many systems, the back-up process may be cumbersome and require significant time or may even require a process interruption to back up data such as device settings of a device or other data generally. Furthermore, in a cloud-enabled environment, a customer may have devices around the world in various time zones and operating in different cultures which observe very different workday mores. In response, certain examples herein provide solutions that facilitate the device and the cloud service to automatically determine a beneficial back-up schedule, including a beneficial default back-up schedule, which takes into account the aforementioned issues.

Many devices (e.g., computing devices, printers, etc.) have data (e.g., stored data, device settings, etc.) for periodic back-up. Again, the backing up of device data is often performed manually. The back-up process may be complicated, and involve a significant amount of time or process interruption. Consequently, a device owner may not back up the device frequently. Moreover, a device owner may forget to back up the device.

In some cases, the backing up of a device may be performed automatically. Automatic back-up of devices communicating with a local or remote server may be performed by the server and may occur at a particular server time. A server-implemented back-up of devices may involve setting each device to back up at a given time based on server time and typically creates load on the server. Furthermore, reduced performance of the back-up and server generally can occur because the server may back up multiple devices at the same time.

An automatic back-up of devices can also occur at an arbitrary predetermined time. Yet, the predetermined time may not be a beneficial or best time given the geographical location of the device. Local workday customs may not be considered. For example, there are natural breaks that occur during the workday depending on local workday customs. These natural breaks may include the end of a shift and the end of the workday. For example, in some cultures, printing presses may generally be restarted each shift, making shift-change time typically a good time to back up device settings. Furthermore, work hours vary from culture to culture so that the end of the workday occurs at different times. For example, some cultures work 2:00 PM to 10:00 PM to be available to buyers on the other side of the world. Other cultures work 7:00 AM to 4:00 PM, leaving evenings available for religious observances, and so forth. Automatic back-up of devices at a predetermined device time may not take advantage of these natural breaks in the workday.

In contrast, cloud-based techniques are provided herein for scheduling the back-up of a device taking into consideration the workday mores of the geographical location of the device. Because of these techniques, an owner having devices located around the world in different cultures can have each device backed up at a time that has less adverse impact on the local work process.

For example, a cloud-based system having an operating system and a registration manager registers a device. The registering may include registration for backing up the device. During registration, the cloud-based system is provided with identification of the time zone in which the device is located. The cloud-based system creates a device record via or in the scheduling manager. A cloud operating system, resource manager, and so forth, may be involved. The scheduling manager (e.g., code stored in cloud memory and executed by a processor or computing device of the cloud) consults a cloud-based data store pre-populated with information about the time zone and geographic location of the device. The information about the time zone and geographic location includes local workday customs. In this manner, local workday mores may be taken into consideration when the scheduling manager schedules a back-up of the device. Alternatively, or in addition to considering local customs, the scheduling manager may consult historical operating data of the device when scheduling the back-up of the device. In general, an advantageous time for a back-up operation to occur is determined. In some examples, the burden of determining a default appropriate back-up time may be lifted from the local site staff or from the global cloud management staff. The techniques may promote back-up operations to transpire at a time having less impact on the local work process.

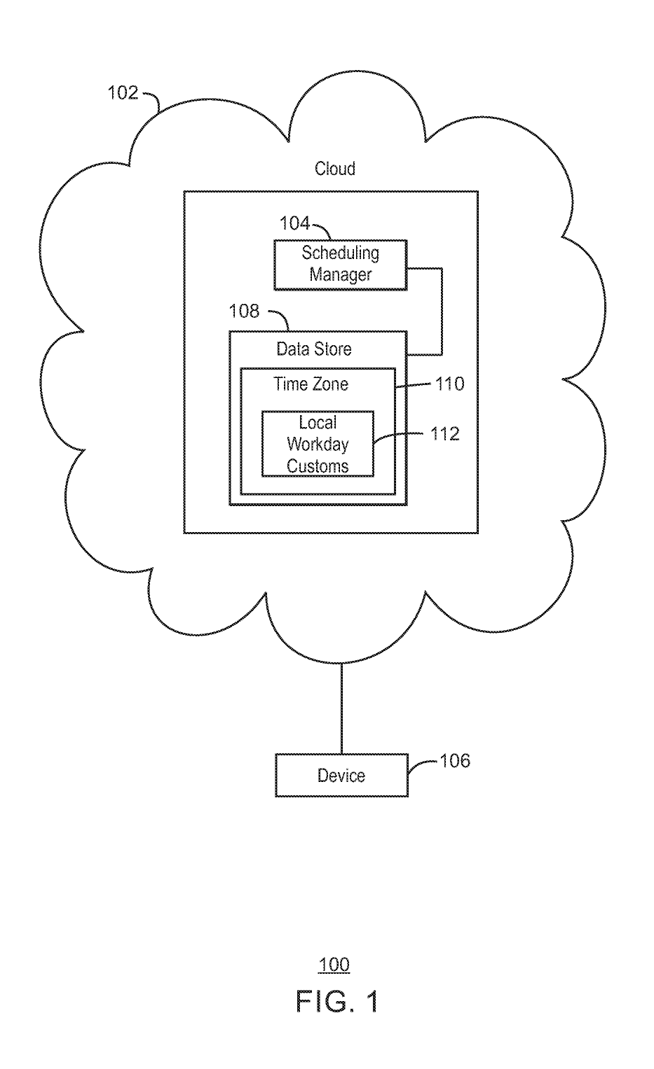

FIG. 1 is a block diagram of an example system 100 for backing up a device. The system 100 may be a computing device or computing system in a cloud 102. The cloud 102 may include data storage systems, computing devices, computing systems including distributed computing systems, and so forth. The cloud 102 or cloud computing may be a type of Internet-based or intranet-based computing that provides services, data, shared computer processing resources, and the like. In some examples, the cloud 102 may provision or provide access to a shared pool of configurable computing resources (e.g., computer networks, servers, storage, applications, services, and etc.). Cloud computing and storage solutions may provide users and enterprises with various capabilities to store and process data in data centers disposed in different geographic locations. Further, a cloud 102 may be beneficial to a service provider providing services to clients or customers having multiple sites and devices disposed at different geographic locations.

The system 100 may include a scheduling manager 104. The scheduling manager 104 may schedule a back-up for a device 106. In scheduling back-up of device 106, the scheduling manager 104 may take into consideration the time zone in which the device 106 is located and workday customs local to the device 106. For example, the scheduling manager 104 may schedule a back-up during a natural break in the local work cycle such as the end of a workday or the end of a shift. The backed up data of the device 106 may be stored in a system in the cloud 102 or in a system, memory, or computing device external to the cloud 102, such as a storage system local to the device 106 or a remote storage system.

The system 100 may also include a data store 108. The data store 108 may store identification of the time zone 110 in which the device 106 is located, the local workday customs 112 for the time zone 110, and the geographic location in which the device 106 is situated. For example, the local workday customs 112 may include the time at which a work day ends or the time at which a shift change occurs. Further the identification of the time zone and the local customs may also be stored in memory of the device 106.

The device to be backed up by the system 100 may be any device that contains data stored in memory of the device that is descriptive and representative of capabilities, actions, or methods of the device. For example, the data requiring back-up may be the configuration of the device, an operating system, data stored in a database, and the computer code for performing a particular technique. Examples of devices requiring back-up include a computing device, a printer, a printing press, a manufacturing control system, a vehicle transportation system, and so on. A computing device may include a desktop computer, a laptop computer, a tablet computer, a smartphone, and the like. A vehicle transportation system may include an airplane, a drone, a car, a truck, and so forth.

The system 100 may include other components not shown in FIG. 1. In examples, the system 100 may also include a registration manager. The registration manager may be code (e.g., instructions or logic) stored in memory and executed by a processor. The registration manager may register the device 106 with an operating system of the system 100 and provide the operating system with the identification of the time zone in which the device is located. The operating system may create a record of the device in the scheduling manager 104. In this way, the scheduling manager 104 becomes aware of the device 106 requiring back-up and the time zone in which the device is located. Once aware of the device 106 and the time zone in which the device is situated, the scheduling manager 104 may consult the data store 108 to access information about the local workday customs 112. In certain examples, the information about the local workday customs 112 is pre-populated in the data store 108.

In other examples, the scheduling manager 104 may consider historical operating data of the device to schedule the time to back up the device. The historical operating data may include job processing data and load usage data. Using this data, the scheduling manager 104 may determine natural lulls in the device usage. The scheduling manager 104 may schedule back-up of the device during these lulls. In this way, the scheduling manager 104 schedules the back-up of the device during a time that will have a reduced negative effect on the device load and throughput.

An implementation may include a device, such as a computing device or a printer, registering with a cloud computing system. If the device is a printer, the printer may be a digital printer, a digital press, a page-wide press, a large format printer, a laser printer, and the like. As for the cloud, cloud computing may include different computing devices and stored code executed by the computing devices to facilitate the registration and to receive relevant information and data from the device. For example, the device or device user may identify the local time zone of the device to an operating system or resource manager code of the cloud computing system. The operating system or the resource manager may create a device record in the resource manager or a scheduling manager code. Further, a resource manager service or the scheduling manager may create an automatic scheduled back-up for the device. In particular examples, the back-up may be a snapshot back-up of the device. In some examples, the resource manager service or the scheduling manager can consult a cloud based data store which contains information about the time zone and location in which the device is situated. This information may then be used to set the automatic scheduled back-up at a beneficial time based on local device time zone, local device workday norms, local device shift norms, and so forth. The techniques may also utilize dynamic heuristics based on operating data from the device to determine a beneficial or appropriate time to schedule a back-up. For example, historical job processing or usage load may be taken into account for the specific device so that the cloud resource manager service or scheduling manager schedules the backup to occur at a time local to the device that will have less negative impact on the device load and throughput.

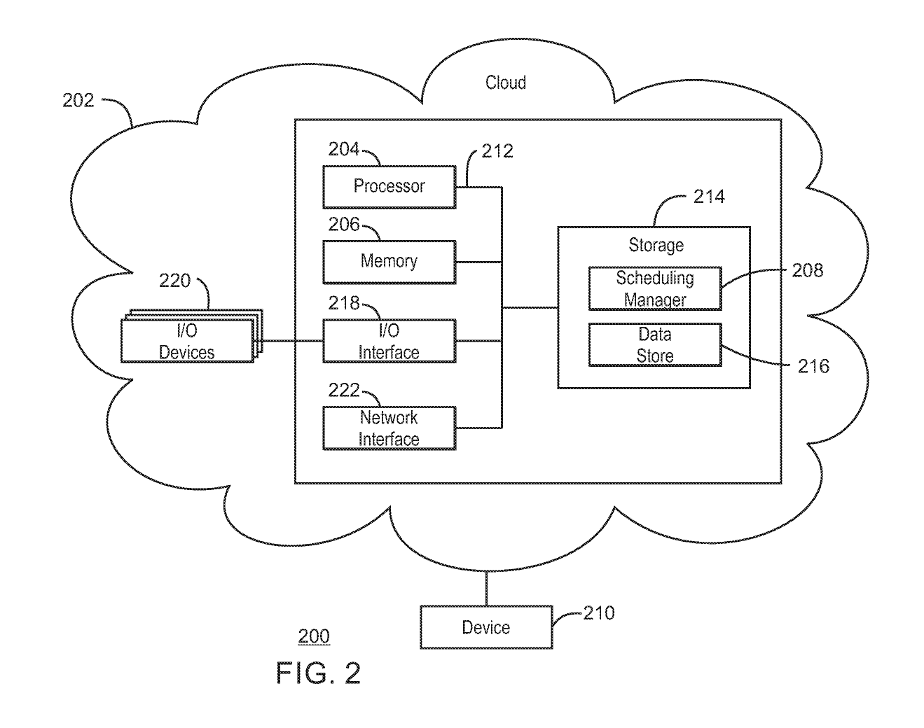

FIG. 2 is a block diagram of an example system 200 for backing up a device at a time based on the time zone in which the device is located and workday customs local to the device. In the illustrated example, the system 200 is a cloud computing system in the cloud 202. The system 200 may include a processor 204 that executes stored instructions, as well as a memory 206 that stores the instructions that are executable by the processor 204. For example, the instructions, e.g., the scheduling manager 208, may tell the processor 204 to back up a device 210.

The processor 204 can be a single core processor, a dual-core processor, a multi-core processor, a number of processors, a computing cluster, and the like. The processor 204 may be coupled to the memory 206 by a bus 212 where the bus 212 may be a communication system that transfers data between various components of the system 200. In examples, the bus 212 may include a Peripheral Component Interconnect (PCI) bus, an Industry Standard Architecture (ISA) bus, a PCI Express (PCIe) bus, high performance links, such as the Intel® Direct Media Interface (DMI) system, and the like.

The memory 206 can include random access memory (RAM), e.g., static RAM (SRAM), dynamic RAM (DRAM), zero capacitor RAM, embedded DRAM (eDRAM), extended data out RAM (EDO RAM), double data rate RAM (DDR RAM), resistive RAM (RRAM), and parameter RAM (PRAM); read only memory (ROM), e.g., mask ROM, programmable ROM (PROM), erasable programmable ROM (EPROM), and electrically erasable programmable ROM (EEPROM); flash memory; or any other suitable memory system.

The system 200 may include storage 214. The storage 214 may include non-volatile storage devices, such as a solid-state drive, a hard drive, a tape drive, an optical drive, a flash drive, an array of drives, or any combinations thereof. In some examples, the storage 214 may include non-volatile memory devices, such as non-volatile RAM (NVRAM), battery backed up DRAM, and the like. In some examples, the memory 206 and the storage 214 may be a single unit, e.g., with a contiguous address space accessible by the processor 204.

In certain examples, the scheduling manager 208 may be stored in the storage 214 of the system 200. The scheduling manager 208 may be executed by a processor, e.g., processor 204. When executed by a processor, the scheduling manager 208 may schedule a back-up of the device 210 based on the time zone in which the device 210 is located and the customs local to the device 210.

The data store 216 may also be stored in the storage 214 of the system 200. As discussed with respect to FIG. 1, the data store 216 may store the identification of the time zone in which the device 210 is located and the workday customs local to the device 210. In examples, the data store 216 may reside on a device external to the system 200. Wherever the data store 216 may be located, the scheduling manager 208 may access the data store 216 and may schedule a back-up for the device 210 depending on the information contained in the data store 216.

The system 200 may also include an input/output (I/O) device interface 218 to connect the system 200 to one or more I/O devices 220. For example, the I/O devices 220 may include a display, a printer, a keyboard, and a pointing device such as a mouse, touchpad, or touchscreen, among others. The input devices may be employed by a user to override the scheduling manager 208 and schedule a device back-up at the user's discretion. The output devices may be used to inform a user of the start time and finish time of the device back-up and the results of the back-up. The I/O devices 220 may be built-in components of the system 200, or may be devices that are externally connected to the system 200. Lastly, the system 200 may also include a network interface 222. The network interface 222 may connect the system 200 to another cloud. The network interface 222 may be a network interface controller (NIC).

The block diagram of FIG. 2 is not intended to indicate that the system 200 for backing up a device is to include all the components shown. Further, any number of additional units may be included within the system 200 depending on the details of the specific implementation.

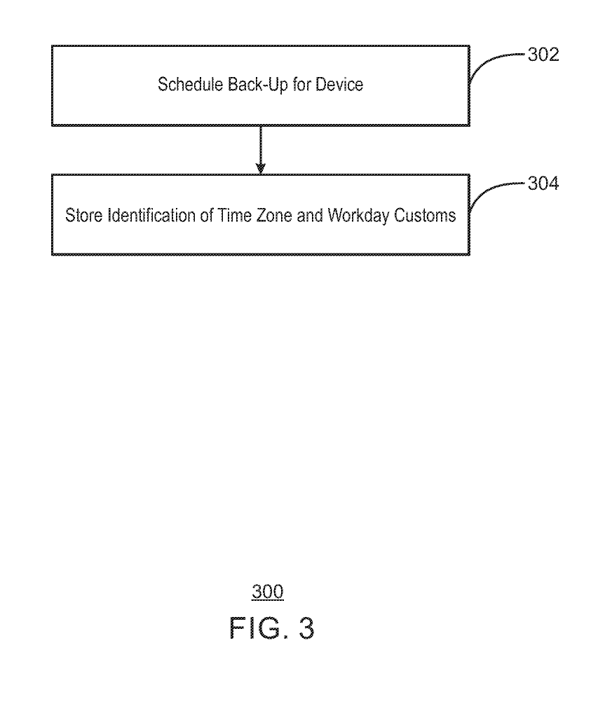

FIG. 3 is a process flow diagram of an example method for backing up a device. The method 300 may be performed by the systems 100 or 200 described with respect to FIGS. 1 and 2, respectively, as well as other systems. The method 300 begins at block 302 with the scheduling of the back-up of a device. The scheduling of the back-up takes into consideration the time zone in which the device is located and the workday customs local to the device. At block 304, the identification of the time zone in which the device is located and the workday customs local to the device are stored in memory. Once stored in memory, the identification of the time zone in which the device is situated and the workday customs local to the device are available for scheduling the back-up of the device. In examples, the memory is pre-populated with the workday customs local to the device.

The process flow diagram of FIG. 3 is not intended to indicate that the method 300 for back-up of a device is to include all the blocks shown. Further, any number of additional blocks may be included within the method 300 depending on the details of the specific implementation.

There are several aspects to the method 300 depicted in FIG. 3. For example, the device to be backed up may be registered with an operating system of a cloud-based system. During registration, the operating system may be provided with the identification of the time zone in which the device is located. A record of the device may be created in memory. After the creation of the device record, back-up of the device is scheduled. During scheduling, the cloud-based memory is consulted. The cloud-based memory has been pre-populated with information about the time zone in which the device is located. This information includes local workday customs.

In another example, historical operating data is considered to determine the time to back up the device. The historical operating data includes job processing data and load processing data. In this alternative, natural lulls in device usage are determined and back-up of the device is scheduled during those lulls. In the various examples and alternatives, the back-up of the device is generally scheduled during a time that will have less adverse impact on the device's load and throughput.

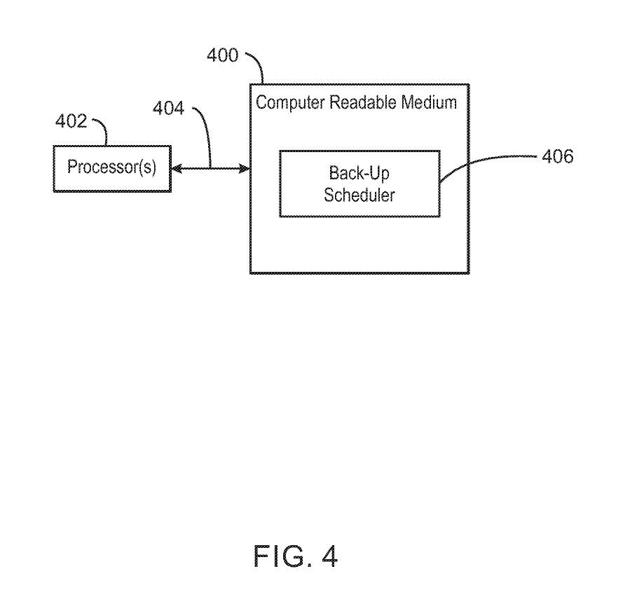

FIG. 4 is a block diagram of an example computer-readable medium storing non-transitory, machine-readable instructions containing code to direct processing resources to schedule a device back-up. The computer-readable medium 400 is coupled to one or more processors 402 via a bus 404. The processor 402 and bus 404 may be as described with respect to the processor 204 and the bus 212 of FIG. 2. The computer-readable medium 400 includes a back-up scheduler 406 to schedule a back-up for the device based on the local workday customs. In an alternative example, back-up scheduler 406 considers historical operating data to schedule a time to back up the device.

The code block described above may be recombined into different blocks that perform the same function. Further, additional blocks may be added. The inclusion of certain code blocks is dictated by the details of the specific implementation.

An example may include a non-transitory, computer-readable medium having machine-readable instructions for backing up a device, the instructions including a scheduling manager which, when executed, directs a processor to schedule a back-up for the device to occur at a time based on a time zone of the device and based on workday customs local to the device, wherein the scheduling manager is to execute in a cloud. The processor may be a component of a computing system in a cloud computing system. The instructions may direct the processor to store identification of the time zone and the local workday customs in a data store. Further, the instructions may direct the processor to register the device with an operating system of a cloud computing system and provide the operating system with the identification of the time zone. Also, the instructions may direct the processor to create a device record of the device in the scheduling manager. Lastly, the instructions including the scheduling manager may direct the processor to consider historical operating data (e.g., of the device) to determine the time to back up the device.

Another example includes a cloud computing system for backing up a device, including a scheduling manager to schedule a back-up of the device to occur at a time based on a time zone in which the device is located and based on workday customs local to the device. The cloud computing system includes a data store storing identification of the time zone and the workday customs. The device may be external to the cloud comprising the cloud computing system and the scheduling manager, and wherein the device comprises data to be backed up. The cloud computing device may include a processor and a memory storing the scheduling manager. The memory may also include the data store. Further, the memory may store a registration manager to register the device with the cloud computing system or with an operating system of the cloud computing system and to provide the cloud computing system or the operating system with the identification of the time zone. The cloud computing system or the operating system may create a device record of the device in the scheduling manager. The scheduling manager may consider historical operating data of the device to determine the time to back up the device. The historical operating data may include job processing data and load usage data.

While the present techniques may be susceptible to various modifications and alternative forms, the examples discussed above have been shown only by way of example. It is to be understood that the technique is not intended to be limited to the particular examples disclosed herein. Indeed, the present techniques include all alternatives, modifications, and equivalents falling within the scope of the present techniques.

What is claimed is:

1. A cloud computing system for backing up a device, comprising:
a scheduling manager to schedule a back-up for the device to occur at a time based on a time zone in which the device is located and based on workday customs local to the device; and
a data store storing identification of the time zone and the workday customs.

2. The cloud computing system of claim 1, wherein the device is external to a cloud comprising the cloud computing system having the scheduling manager, and wherein the device comprises data to be backed up.

3. The cloud computing system of claim 1, comprising a cloud computing device comprising a processor and a memory storing the scheduling manager.

4. The cloud computing system of claim 3, wherein the memory comprises the data store.

5. The cloud computing system of claim 3, wherein the memory stores a registration manager to register the device with an operating system of the cloud computing system and to provide the operating system with the identification of the time zone.

6. The cloud computing system of claim 5, wherein the operating system creates a device record of the device in the scheduling manager.

7. The cloud computing system of claim 1, wherein the scheduling manager considers historical operating data of the device to determine the time to back up the device.

8. The cloud computing system of claim 7, wherein the historical operating data comprises job processing data and load usage data.

9. A method for backing up a device, comprising:
scheduling a back-up for the device to occur at a time based on a time zone in which the device is located and based on workday customs local to the device; and
storing identification of the time zone and the workday customs.

10. The method of claim 9, wherein the device is external to a cloud comprising a scheduling manager, and wherein the device comprises data to be backed up.

11. The method of claim 9, wherein a cloud computing device comprises a processor and a memory storing the scheduling manager.

12. The method of claim 11, wherein the memory comprises the data store.

13. The method of claim 11, comprising:
registering the device with an operating system of the cloud computing device; and
providing the operating system with the identification of the time zone.

14. The method of claim 13, comprising creating a device record of the device in the scheduling manager.

15. The method of claim 9, comprising considering historical operating data to determine the time to back up the device, and wherein the historical operating data comprises job processing data and load usage data.

16. A non-transitory, computer readable medium comprising machine-readable instructions for backing up a device, the instructions comprising a scheduling manager, when executed, direct a processor to schedule a back-up for the device to occur at a time based on a time zone of the device and based on workday customs local to the device, wherein the scheduling manager to execute in a cloud computing system.

17. The non-transitory, computer readable medium of claim 16, wherein the instructions direct the processor to store in a data store identification of the time zone and the local workday customs.

18. The non-transitory, computer readable medium of claim 16, wherein the instructions direct the processor to:
register the device with an operating system of a cloud computing device; and
provide the operating system with the identification of the time zone.

19. The non-transitory, computer readable medium of claim 16, wherein the instructions direct the processor to create a device record of the device in the scheduling manager.

20. The non-transitory, computer readable medium of claim 16, wherein the instructions comprising the scheduling manager direct the processor to consider historical operating data to determine the time to back up the device.
